(19) United States
(12) Patent Application Publication
(10) Pub. No.: US 2024/0022694 A1
(43) Pub. Date: Jan. 18, 2024

(54) CAMERA DEVICE CAPABLE OF PAN-TILT-ZOOM OPERATION AND VIDEO SURVEILLANCE SYSTEM AND METHOD USING THE SAME

(71) Applicant: IDIS CO., LTD., Daejeon-si (KR)

(72) Inventors: Hyun Bin KIM, Seongnam-si (KR); Chan Hee SHIN, Seoul (KR)

(73) Assignee: IDIS CO., LTD., Daejeon-si (KR)

(21) Appl. No.: 18/221,209

(22) Filed: Jul. 12, 2023

(30) Foreign Application Priority Data
Jul. 13, 2022 (KR) 10-2022-0086174

(51) Int. Cl. H04N 7/18; G06T 3/00; H04N 23/63; H04N 23/69; H04N 23/695

(52) U.S. Cl. CPC H04N 7/185; G06T 3/0018; H04N 23/632; H04N 23/69; H04N 23/695

(57) ABSTRACT

Disclosed is a technology related to a video surveillance system using a camera capable of a pan-tilt-zoom operation. The video surveillance system includes a pan-tilt-zoom camera for photographing a surveillance region, and a display device for outputting an image of the pan-tilt-zoom camera. The pan-tilt-zoom camera provides a fisheye image representing an entire surveillance region onto a first region of the display device, calculates driving parameters of the pan-tilt-zoom camera on the basis of location information of a portion selected from the fisheye image, moves the pan-tilt-zoom camera to a location of the selected portion according to the driving parameters, and provides a monitoring image of the selected portion photographed by the pan-tilt-zoom camera onto a second region of the display device. According to the present invention, the pan-tilt-zoom camera is allowed to be intuitively and rapidly controlled using the fisheye image and to rapidly generate a fisheye image.

### CROSS-REFERENCE TO RELATED APPLICATION(S)

This application claims priority from Korean Patent Application No. 10-2022-0086174, filed on Jul. 13, 2022, in the Korean Intellectual Property Office, the disclosure of which is incorporated herein by reference in its entirety.

### BACKGROUND

### 1. Field

The present invention relates to a surveillance system for remotely monitoring a surveillance region, and more particularly, to a surveillance system that controls a pan-tilt-zoom camera for photographing a surveillance region using a fisheye image, and a camera device.

### 2. Description of Related Art

Surveillance cameras are being used as the most effective tool for preventing ever-increasing crimes in an increasingly complex society and recording and checking daily human behavior. Although there are negative aspects such as invasion of privacy and the like caused by surveillance cameras, the necessity and importance of surveillance cameras are increasing, and accordingly, the demand for surveillance cameras is rapidly increasing.

Recently, camera devices that use a fisheye lens camera to monitor an entire region to be monitored and that use a pan-tilt-zoom camera to precisely monitor a designated specific region of the region to be monitored have been released. A fisheye lens is a familiar interface for surveillance system administrators because the fisheye lens shows a surveillance region at a glance. However, since distortion occurs in fisheye images, pan-tilt-zoom cameras are usually used for detailed surveillance regions.

Korean Patent Registration No. 10-1179131 published on Sep. 7, 2012 relates to a surveillance system using a pan-tilt-zoom function-integrated simultaneous surveillance camera, and in this document, a configuration including a camera device unit that captures omnidirectional (360 degree) long-distance videos of a surveillance region through a pan-tilt-zoom camera with which a wide-angle lens is integrated, a video signal processing unit that converts signals of a distorted long-distance video captured by the camera device unit into image data, a central processing unit that selects a flattened region (unwrapping region) from among the distorted image data of the video signal processing unit to form a region of interest (ROI), converts a required curved region of the ROI into a flat image using a lookup table to display the flat image on a monitor, restores the flat image to an original image through an image calibration process, and configures at least one monitoring screen, and a concentrated monitoring unit that uses the pan-tilt-zoom camera to enlarge a specific region of the image restored by the central processing unit and configures and displays a focused monitoring screen is disclosed. However, since a distorted image is always obtained due to the wide-angle lens coupled to the front of the pan-tilt-zoom camera, there is a problem in that a dewarping process is required for an image of a surveillance region.

Korean Laid-open Patent Application No. 10-2017-0136904 published on Dec. 12, 2017 relates to a monitoring device and monitoring system that can monitor a correction image with more emphasis by displaying a correction image in a large size and by displaying an original image as a mini-map when a user desires, and the monitoring device including a communication unit that receives an original image obtained by a camera, a storage unit configured to store the original image, a screen unit that displays the original image and a correction image obtained by dewarping the original image, and a control unit that controls operations of the communication unit, the storage unit, and the screen unit, wherein the screen unit displays a mini-map representing the original image on a portion of the corrected image is disclosed. However, since a distorted image is always obtained due to using a fisheye camera, there is a problem in that a dewarping process is required for an image of a surveillance region.

Korean Patent Registration No. 10-2193984 published on Dec. 22, 2020 relates to a pan-tilt-zoom (PTZ) camera control method using a fisheye camera in a state in which the fisheye camera and the PTZ camera are installed adjacently, and in this document, a configuration including selecting an ROI from an entire image of a region to be monitored photographed by the fisheye camera, and adjusting a pan angle P and a tilt angle T of the PTZ camera to obtain a precise image of the selected ROI, wherein the adjusting of the pan angle P and the tilt angle T of the PTZ camera includes first adjusting the pan angle P and the tilt angle T of the PTZ camera to be parallel to an optical axis whose center is the ROI, of the fisheye camera, and in the state in which the panning angle P and the tilt angle T are firstly adjusted, secondarily adjusting the pan angle P and the tilt angle T of the PTZ camera on the basis of a difference value between a distance from the PTZ camera to a center of an image of the ROI in the captured image and a distance from the PTZ camera to a center of the captured image is disclosed. However, although a PTZ image can be obtained directly, both the fisheye camera and the PTZ camera are included, and thus a system configuration is complicated and manufacturing costs are increased.

Therefore, there is a need to develop a simple video surveillance system that can easily manipulate a pan-tilt-zoom camera using a fisheye image and directly provide an undistorted pan-tilt-zoom camera image for a surveillance region.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a surveillance system that can intuitively, rapidly, and easily control a pan-tilt-zoom camera from a fisheye image.

The following description also relates to a surveillance system that rapidly forms a fisheye image using small computational resources when forming the fisheye image from a pan-tilt-zoom camera image.

The following description also relates to a surveillance system that can be configured inexpensively and is easy to maintain.

In one general aspect, a camera device capable of a pan-tilt-zoom operation includes a memory configured to store monitoring image data and a processor electrically coupled to the memory. The processor is configured to generate a fisheye image representing an entire surveillance region to output the generated fisheye image to an external device, calculate driving parameters for the pan-tilt-zoom operation of the camera on the basis of the location information of the portion selected from the fisheye image, and output and provide data of the monitoring image obtained by capturing the selected portion to the external device.

The fisheye image may be generated by extracting predetermined pixels from a partial image captured in each of partial regions divided by a preset method, among the entire surveillance region.

The fisheye image may be updated using pieces of image data for a partial region rephotographed for each of partial regions divided by a preset method, among the entire surveillance region, at preset periods.

The processor may be further configured to display, on the fisheye image, a preset region in which a location where photographing is performed is preset, among the surveillance region.

The driving parameters may include a pan angle and a tilt angle for photographing a center of the selected portion and a zoom magnification set by a ratio of a field of view of the selected portion to a field of view of a camera.

In another general aspect, a video surveillance system using a camera capable of a pan-tilt-zoom operation includes a camera capable of a pan-tilt-zoom operation configured to photograph a surveillance region, a display configured to output an image of the camera, and a control unit configured to drive the camera and transmit an image captured by the camera to the display. The control unit includes a fisheye image providing unit that provides a fisheye image representing an entire surveillance region to a first region of the display, a driving parameter calculating unit that calculates driving parameters for the pan-tilt-zoom operation of the camera on the basis of location information of a portion selected from the fisheye image, and a monitoring image providing unit that provides a monitoring image obtained by capturing the selected portion to a second region of the display.

The fisheye image providing unit may provide a fisheye image generated by synthesizing and distorting a plurality of partial images obtained by capturing preset partial regions obtained by dividing the entire surveillance region.

The fisheye image providing unit may provide a fisheye image generated by extracting predetermined pixels from each of partial images obtained by capturing preset partial regions obtained by dividing the entire surveillance region.

The control unit may further include a preset map providing unit that displays, on the fisheye image, a preset region in which a location where photographing is performed is preset, among the surveillance region.

The driving parameter calculating unit may calculate a pan angle and a tilt angle to allow the camera to be directed to a center of the selected portion, and set a zoom magnification of the pan-tilt-zoom camera using a ratio of a field of view of the selected portion to a field of view of the camera.

In still another general aspect, a video surveillance method using a camera capable of a pan-tilt-zoom operation includes providing a fisheye image representing an entire surveillance region, calculating driving parameters for the pan-tilt-zoom operation of the camera on the basis of location information of a portion selected from the fisheye image, moving the camera to be directed to the selected portion using the driving parameters, and providing a monitoring image of the selected portion photographed by the pan-tilt-zoom camera.

The providing of the fisheye image may include dividing the entire surveillance region into preset partial regions and capturing a partial image in each of the partial regions, and extracting predetermined pixels from each captured partial image and generating the fisheye image.

The video surveillance method may further include providing a preset map that displays, on the fisheye image, a preset region in which a location where photographing is performed is preset, among the surveillance region.

The calculating of the driving parameter may include calculating a pan angle and a tilt angle to allow the camera to be directed to a center of the selected portion, and set a zoom magnification of the camera using a ratio of a field of view of the selected portion to a field of view of the camera.

### BRIEF DESCRIPTION OF THE DRAWINGS

FIG. 1 is a configuration diagram illustrating an overall configuration of a video surveillance system using a camera capable of a pan-tilt-zoom operation according to an embodiment.

FIG. 2 is a conceptual diagram illustrating a configuration of a screen displayed on a display of a video surveillance system using a camera capable of a pan-tilt-zoom operation according to an embodiment.

FIGS. 3A and 3B are a set of configuration diagrams illustrating main components of a control unit of a video surveillance system using a camera capable of a pan-tilt-zoom operation according to an embodiment.

FIG. 4 is a configuration diagram illustrating additional components of a control unit of a video surveillance system using a camera capable of a pan-tilt-zoom operation according to an embodiment.

FIGS. 5A and 5B are a set of conceptual diagrams illustrating camera control and a preset map using a fisheye image in a video surveillance system using a camera capable of a pan-tilt-zoom operation according to an embodiment.

FIGS. 6A and 6B are a set of conceptual diagrams illustrating a method of generating a fisheye image by distorting a pan-tilt-zoom image in a video surveillance system using a camera capable of a pan-tilt-zoom operation according to an embodiment.

FIG. 7 is a conceptual diagram illustrating a method of generating a fisheye image by matching pixels of a pan-tilt-zoom image with the fisheye image in a video surveillance system using a camera capable of a pan-tilt-zoom operation according to an embodiment.

FIG. 8 is a flowchart illustrating a video surveillance method using a camera capable of a pan-tilt-zoom operation according to an embodiment.

FIG. 9 is a flowchart illustrating an operation of providing a fisheye image in a video surveillance method using a camera capable of a pan-tilt-zoom operation according to an embodiment.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described with reference to the accompanying drawings. It is understood that components of each embodiment are possible in various combinations within one embodiment or with components of another embodiment unless otherwise stated or inconsistent with each other. Based on the principle that the inventor can adequately define the concept of terms in order to describe his or her invention in the best possible way, terms used in this specification and claims should be interpreted as meanings and concepts consistent with the description or proposed technical idea. In this specification, a module or portion may be a set of program instructions stored in a memory to be executed by a computer or processor, or may be implemented using a set of electronic components or circuits such as an application specific integrated circuit (ASIC), a field-programmable gate array (FPGA), or the like to execute these instructions. Further, the operation of each module or portion may be performed by one or a plurality of processors or devices.

Hereinafter, exemplary embodiments of the present invention will be described in detail with reference to the accompanying drawings.

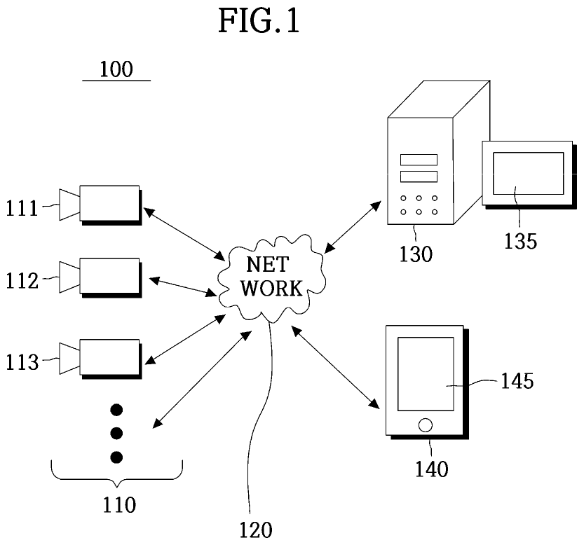

FIG. 1 is a configuration diagram illustrating an overall configuration of a video surveillance system using a camera capable of a pan-tilt-zoom operation according to an embodiment.

Referring to FIG. 1, a video surveillance system 100 according to the embodiment includes one or more cameras 110 for photographing a surveillance region, and clients 130 and 140 connected to the cameras 110 through a network 120. Examples of the cameras 110 may include pan-tilt-zoom cameras capable of adjusting a pan angle, a tilt angle, and a zoom magnification to increase a surveillance region to be photographed. A plurality of cameras 111, 112, . . . may be used to monitor an entire region such as a building divided into a plurality of regions. The network 120 through which the cameras and the clients are connected may be implemented as a wired communication network or a wireless communication network. Examples of the clients 130 and 140 may include personal computers (PCs), tablet computers, laptop computers, mobile phones, and the like. The clients include displays 135 and 145 to show captured content of the surveillance region. In this specification, the term “display” is used as a concept including not only the displays 135 and 145, but also the clients 130 and 140 that are coupled to the displays 135 and 145 to drive the displays. In FIG. 1, although the display is illustrated as being connected to the camera through the network, the display may be directly connected to the camera or may be manufactured as a component embedded into the camera.

According to an aspect of the proposed invention, the video surveillance system 100 using the camera capable of the pan-tilt-zoom operation includes a camera, a display, and a control unit. The cameras 110 are capable of a pan-tilt-zoom operation and photograph a surveillance region. The displays 135 and 145 are devices that output images of the cameras. In this specification, the control unit drives the cameras and transmits the images photographed by the cameras to the displays.

The control unit may be embedded in each of the cameras 111, 112, . . . or may be installed in a client. In the case of controlling a plurality of cameras, the client's burden increases, and in the case of a mobile phone, computational resources are insufficient, and thus it is preferable to embed the control unit in each of the cameras 111, 112, . . . .

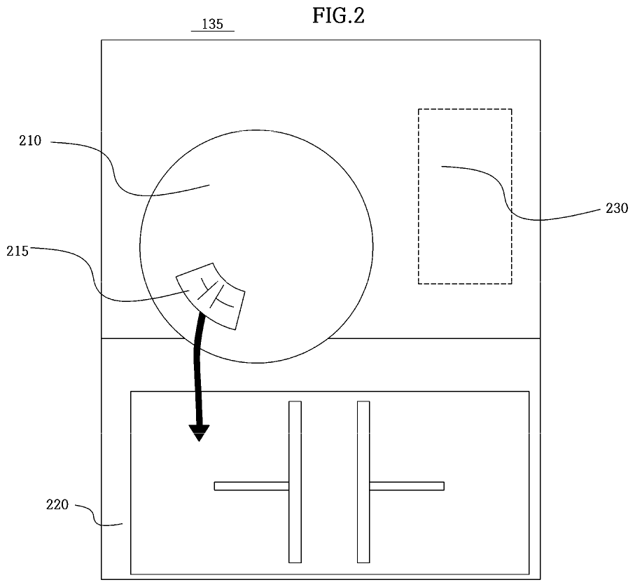

FIG. 2 is a conceptual diagram illustrating a configuration of a screen displayed on a display of a video surveillance system using a camera capable of a pan-tilt-zoom operation according to an embodiment.

Examples of the displays 135 and 145 may include monitors, personal digital assistants (PDAs), tablet computers, mobile phones, and the like that have a display unit capable of outputting a video, such as a liquid-crystal display (LCD), an organic light-emitting diode (OLED), or the like. When a touch panel is used for the displays 135 and 145, an input may be received from the user through the displays. The display unit of each of the displays 135 and 145 includes a first region 210 and a second region 220 on which different videos are output. For example, a fisheye image may be output onto the first region 210, and an image photographed by a pan-tilt-zoom camera may be output onto the second region 220. Referring to FIG. 2, a pan-tilt-zoom camera image corresponding to a portion 215 of the fisheye image of the first region 210 indicated in yellow green is output onto the second region 220.

The first region 210 may overlap the second region 220. For example, the fisheye image of the first region 210 may be output to a portion of the second region 220. The display device 150 may further include a third region 230. For example, preset setting information or a command for controlling the camera may be displayed on the third region 230.

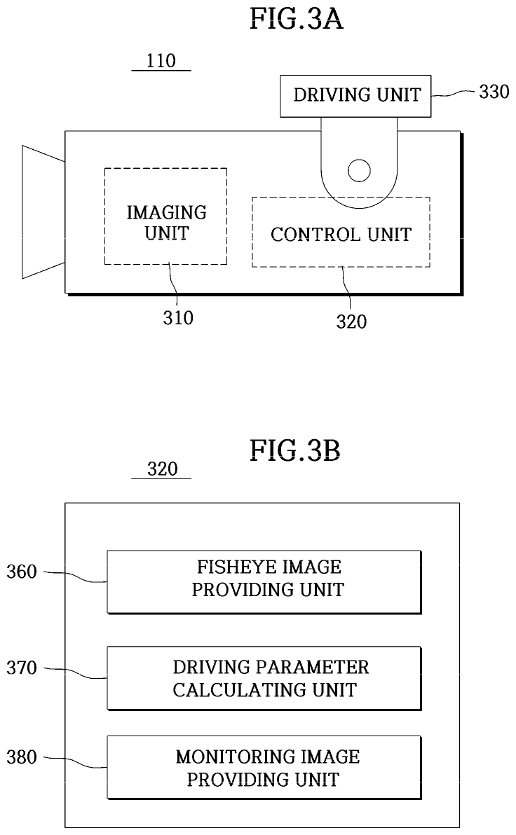

FIG. 3 is a set of configuration diagrams illustrating main components of a control unit of a video surveillance system using a camera capable of a pan-tilt-zoom operation according to an embodiment.

In an example of FIG. 3A, the control unit is a component embedded in a pan-tilt-zoom camera, but in another example, the control unit may be configured in a separate device. An imaging unit 310 includes various types of lenses and image sensors and captures an image of a surveillance region. A driving unit 330 adjusts a pan angle, a tilt angle, and a zoom magnification of the camera to allow the imaging unit of the camera to be directed in a direction to be captured. A control unit 320 includes a memory and a processor, controls the image captured by the imaging unit to be stored in the memory or transmitted to externally connected output devices, and controls the driving unit to allow the camera to be directed to a location requested by an external input device.

According to another aspect of the proposed invention, the camera 110 capable of a pan-tilt-zoom operation includes a memory and a processor. The memory is configured to store monitoring image data. The processor is electrically coupled to the memory and controls the operation of the camera.

FIG. 3B is a configuration diagram illustrating main components of the control unit 320. The control unit 320 includes a fisheye image providing unit 360, a driving parameter calculating unit 370, and a monitoring image providing unit 380. The fisheye image providing unit 360 provides a fisheye image representing an entire surveillance region onto a first region of a display. The driving parameter calculating unit 370 calculates driving parameters for the pan-tilt-zoom operation of the camera on the basis of location information of a portion selected from the fisheye image. The monitoring image providing unit 380 provides a monitoring image obtained by capturing the selected portion onto a second region of the display.

These components may be operated by the processor of the control unit. That is, the processor may be configured to generate a fisheye image representing an entire surveillance region to output the generated fisheye image to an external device, calculate driving parameters for the pan-tilt-zoom operation of the camera on the basis of the location information of the portion selected from the fisheye image, and output and provide data of the monitoring image obtained by capturing the selected portion to the external device.

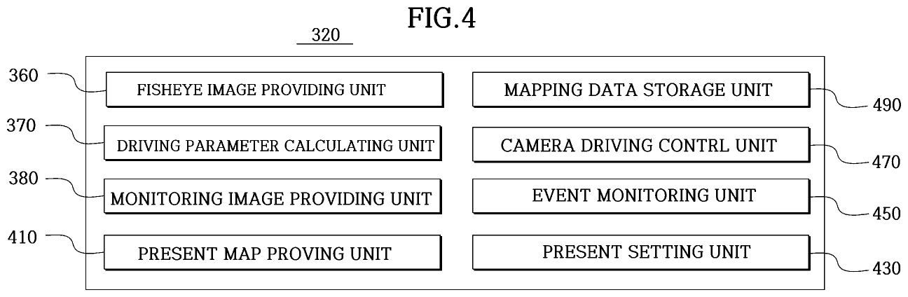

FIG. 4 is a configuration diagram illustrating additional components of the control unit of the video surveillance system using the camera capable of a pan-tilt-zoom operation according to the embodiment.

According to an additional aspect, the control unit 320 further includes a camera driving control unit 470. The camera driving control unit 470 performs the pan-tilt-zoom operation of the camera according to the driving parameters to move the camera to a location where photographing is to be performed. When the pan-tilt-zoom operation is performed, the camera is directed to the location where photographing is to be performed, an image is captured through the imaging unit and is input, and the captured image is stored in the memory.

According to an additional aspect, the control unit 320 further includes an event monitoring unit 450. The event monitoring unit 450 monitors whether there is an input by the user and whether an abnormality has occurred in the surveillance region. When events are detected, a predetermined procedure is performed in response to each event. For example, when information indicating that a specific portion of the fisheye image is selected is received from the user, the pan-tilt-zoom camera may be moved to a center of the specific portion, the screen may be enlarged to fit the corresponding region, and then the captured image may be stored or may be transmitted to the display. When an abnormality that has occurred in a specific surveillance region is detected, the camera may be moved to a center of the corresponding region, and an alarm may be generated.

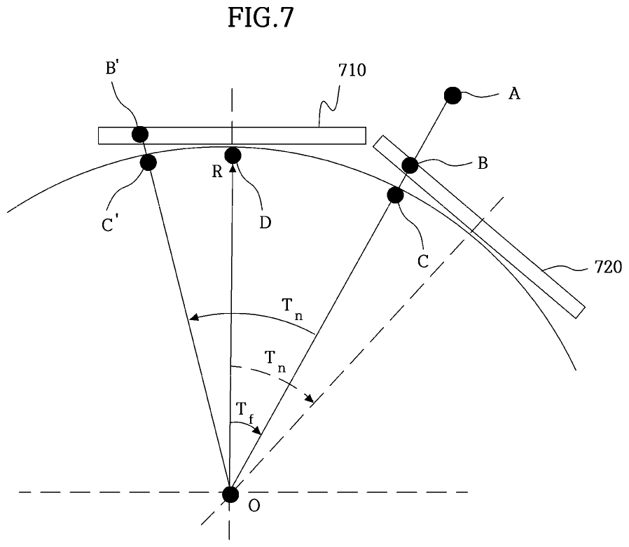

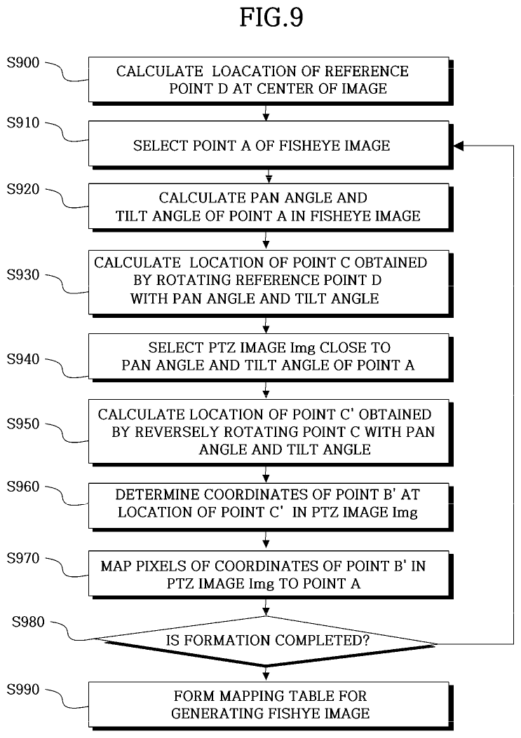

According to an additional aspect, the control unit 320 further includes a mapping data storage unit 490. The mapping data storage unit 490 is configured to store mapping data used for the fisheye image in a storage device, such as a memory or the like, for fast calculation when the fisheye image is generated. The mapping data will be described in detail in descriptions of FIGS. 7 and 9.

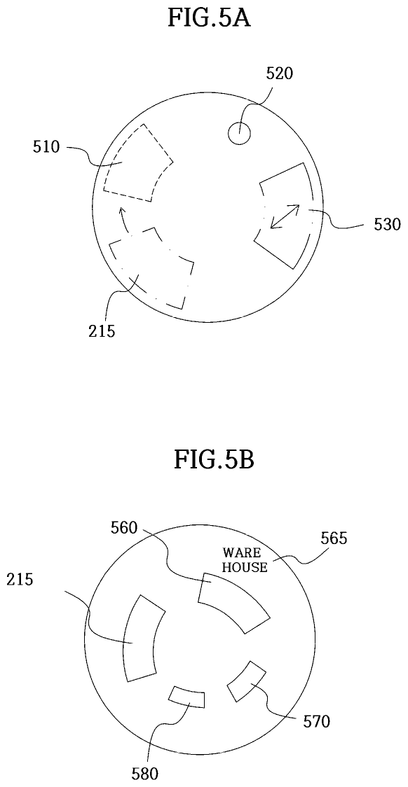

FIG. 5 is a set of conceptual diagrams illustrating camera control and a preset map using a fisheye image in a video surveillance system using a camera capable of a pan-tilt-zoom operation according to an embodiment.

In FIG. 5A, a user's operation of changing a surveillance region of the pan-tilt-zoom camera using an input device such as a touch panel, a mouse, or the like in a fisheye image is displayed in orange. By dragging a surveillance region 215 where photographing is being currently performed, which is displayed in yellow green, the pan-tilt-zoom camera may be adjusted to photograph and monitor a new region 510. A user input is transmitted to the control unit 320 through a touch panel, a mouse, or the like, and the control unit moves a central location of the pan-tilt-zoom camera to the center of the new region 510. An image of the new region 510 photographed by the pan-tilt-zoom camera is output to the second region 220 of the display.

The user may click an arbitrary location 520 in the fisheye image and allow the pan-tilt-zoom camera to monitor a new region. In addition, the user may drag an arbitrary region and allow the camera to photograph a dragged region 530. In this case, a pan angle and a tilt angle of the pan-tilt-zoom camera may be adjusted so that the pan-tilt-zoom camera is directed to the center of the dragged region 530, and a zoom magnification of the pan-tilt-zoom camera may be adjusted to include the dragged region.

According to an additional aspect, the control unit 320 further includes a preset setting unit 430 for setting a preset region, in which a location where photographing is performed is preset, among the surveillance region, and a preset map providing unit 410 for displaying the preset region on a fisheye image. That is, the processor of the control unit 320 is further configured to set the preset region, in which the location where photographing is performed is preset, among the surveillance region, and to display the set preset region on the fisheye image.

The preset setting unit 430 receives and stores location information about a specific surveillance region from the user. As the location information, a specific location in the fisheye image may be received or a location of the dragged region in the fisheye image may be received. When setting the preset region, driving parameters of the pan-tilt-zoom operation may also be set using the location and size of a central point at the location where photographing is performed. The set preset region may be stored in a storage device, a non-volatile memory, or the like.

FIG. 5B shows an example of a preset map displayed in blue on a fisheye image. The user may preset a frequently moved surveillance region as a preset region. The preset map is a map in which previously set preset regions are displayed on the fisheye image. When the preset setting unit 430 receives a specific surveillance region from the user, the preset setting unit 430 may obtain a pan angle and a tilt angle of the center, calculate a zoom magnification for photographing the corresponding region, and store the pan angle, the tilt angle, and the zoom magnification. Referring to FIG. 5B, three preset regions 560, 570, and 580 are displayed on the preset map. In the fisheye image, the preset region 580 having a small size has a higher zoom magnification than the preset map 560 having a large size. Meanwhile, a separate identifier may be added to the preset map. For example, an identifier 565 called “warehouse” is displayed on the upper preset region 560.

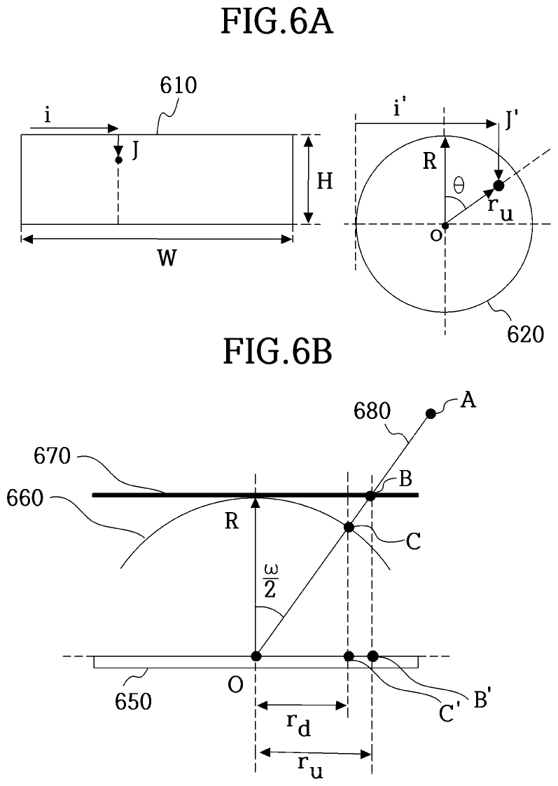

FIG. 6 is a set of conceptual diagrams illustrating a method of generating a fisheye image by distorting a pan-tilt-zoom image in a video surveillance system using a camera capable of a pan-tilt-zoom operation according to an embodiment.

According to an additional aspect, fisheye image data may be generated by synthesizing and distorting a plurality of pieces of partial image data of an entire surveillance region photographed by a pan-tilt-zoom camera.

FIG. 6A is a conceptual diagram illustrating an example in which a pan-tilt-zoom camera image is converted into a fisheye image. A quadrilateral region 610 on the left of FIG. 6A represents data obtained by synthesizing a plurality of partial images of the entire surveillance region photographed by the pan-tilt-zoom camera. A distance rᵤ from a center of a fisheye image 620 with a radius R and a pan angle θ may be obtained using coordinates (i, j) of the synthesized image having a width W and a height H using Equation 1 below.

θ=i/W*360 [Equation 1]

rᵤ=R(1−j/H) [Equation 1]

When entire pixels of the fisheye image are F*F, coordinates (I′, j′) of the fisheye image may be obtained using Equation 2 below.

i′=F/2+r cos θ

j′=F/2−r sin θ [Equation 2]

FIG. 6B is a conceptual diagram illustrating another example in which the pan-tilt-zoom camera image is converted into the fisheye image. The pan-tilt-zoom camera image may be converted into the fisheye image using a field of view (FOV) model. A location where an external point A forms an image on a sensor plane is located on a straight line 680 passing through the external point A and a center O of the camera. In a pinhole model, the point A forms an image on at a point B where the straight line 680 meets an image plane 670 at a focal length R. That is, the distance rᵤ from the center to an undistorted image on an image sensor 650 corresponds to a distance from the center O to the point B on the plane or a point B′ projected onto the sensor.

In an FOV model, in the case of a fisheye lens, an image is formed at a point C′ obtained by projecting a point C where the straight line 680 meets a sphere 660 with a radius R onto the image sensor 650. In this case, a distance rd from the center O to the point C′ at which spherically distortion occurs on the image sensor 650 may be obtained using Equation 3 below.

$${r}_{d} = \frac{1}{ω} arctan ( 2 {r}_{u} tan \frac{ω}{2} ) \qquad [ Equation 3 ]$$

Here, ω denotes a distortion coefficient representing the degree of distortion. In the case of using a fisheye lens, the distortion coefficient ω may be estimated to minimize an error function for the distortion coefficient ω. In the case of using a pan-tilt-zoom camera, a tilt FOV may be used for the distortion coefficient ω of the fisheye image.

High-resolution image synthesis requires many computational resources. For example, when a pan-tilt-zoom camera with a horizontal FOV of 56 degrees and a vertical FOV of 35 degrees is used, it is possible to photograph the entire surveillance region at a pan angle interval of 45 degrees and a tilt angle interval of 25 degrees to 100 degrees in order to photograph the entire surveillance region without gaps. Since a pan angle of the entire region is 360 degrees, 8 images are required horizontally and 4 images are required vertically for a tilt angle of 117.5 degrees (=100 degrees+35 degrees/2). That is, about 32 (=8*4) images are required for the entire surveillance range. In the case of a 2 M (1,920*1,080) image, a very large number of operations of about 2M*32=64 M are required for image synthesis and conversion.

In order to reduce an amount of computation and memory usage to generate the fisheye image, a method of matching pixels of the image captured by the pan-tilt-zoom camera to pixels of the fisheye image may be used. Since pixels of size 1,000*1,000 of the fisheye image are 785 k (=π*5002), not only can computational resources be saved by reducing the calculation to about 0.8 M, but also a time for generating the fisheye image can be significantly reduced.

FIG. 7 is a conceptual diagram illustrating a method of generating a fisheye image by matching pixels of a pan-tilt-zoom image with the fisheye image in a video surveillance system using a camera capable of a pan-tilt-zoom operation according to an embodiment.

According to an additional aspect, the fisheye image providing unit provides a fisheye image generated by extracting predetermined pixels from a plurality of partial images of an entire surveillance region photographed by the pan-tilt-zoom camera.

Referring to FIG. 7, coordinates of a point B of an image 720 of the pan-tilt-zoom camera with a tilt angle Tₙ may be matched with coordinates of a point A at a location of a tilt angle T_{f} from a center O of the fisheye image. In order to obtain the coordinates of the point B, a sphere whose radius is a focal length R of the pan-tilt-zoom camera is considered. When a reference point D at a center of a pan-tilt-zoom camera image 710 with a tilt angle of 0 degrees is rotated by the tilt angle T_{f} of the fisheye image, a point C on the sphere directed to the point A may be obtained. When the point C is reversely rotated by the tilt angle Tₙ of the pan-tilt-zoom camera image 720, coordinates of a point C′ may be obtained from the pan-tilt-zoom camera image, and coordinates of a point B′ may be obtained by projecting the coordinates of a point C′ onto the pan-tilt-zoom camera image 710 with the tilt angle 0 degrees. Since the coordinates of the point B′ is the same in the image 720 of the pan-tilt-zoom camera with the tilt angle Tₙ, the coordinates of the point B′ of the pan-tilt-zoom camera image 720 with the tilt angle Tₙ may be matched or mapped to the coordinates of the point A at the location of the tilt angle T_{f} in the fisheye image. When the image of the pan-tilt-zoom camera is mapped to all the points of the fisheye image, the fisheye image may be formed at high speed while using less computational resources. Such mapping data may be stored using the mapping data storage unit 490.

Hereinafter, rotational transform in consideration of both the pan angle and the tilt angle will be described. First, in a reference coordinate system in which both a pan angle and a tilt angle are 0 degrees, coordinates (R, 0, 0) of the reference point D at the center of the camera image may be obtained using the focal length R in Equation 4 below.

R=(H/2)tan(ω/2) [Equation 4]

Here, ω denotes an FOV of the pan-tilt-zoom camera, and H denotes an image length in a direction of an FOV.

In a fisheye coordinate system whose origin is a center of a fisheye image, when coordinates of a point representing the point A are Fx pixels on a horizontal axis and Fy pixels on a vertical axis, a pan angle P_{f} and a tilt angle T_{f} of the point A may be obtained using Equation 5 below.

P_{f}=arctan(Fy/Fx)

T_{f}=Tₘ*(d/R_{f}) [Equation 5]

Here, Tₘ denotes a tilt range, d denotes a pixel distance from the origin to a point P, and R_{f} denotes a pixel distance corresponding to a radius of the fisheye image. The tilt range Tₘ may be obtained by adding half of the FOV to a maximum FOV of the fisheye camera or a maximum tilt value of the pan-tilt-zoom camera.

Meanwhile, a rotational transform matrix W for rotation with the pan angle P_{f} and the tilt angle T_{f} may be obtained using Equation 6 below.

$$\begin{matrix}W = [ \begin{matrix}cos ( {P}_{f} ) & - sin ( {P}_{f} ) & 0 \\ sin ( {P}_{f} ) & cos ( {P}_{f} ) & 0 \\ 0 & 0 & 1\end{matrix} ] [ \begin{matrix}sin ( {T}_{f} ) & 0 & cos ( {T}_{f} ) \\ 0 & 1 & 0 \\ - cos ( {T}_{f} ) & 0 & sin ( {T}_{f} )\end{matrix} ] \\ = [ \begin{matrix}cos ( {P}_{f} ) sin ( {T}_{f} ) & - sin ( {P}_{f} ) & cos ( {P}_{f} ) cos ( {T}_{f} ) \\ sin ( {P}_{f} ) sin ( {T}_{f} ) & cos ( {P}_{f} ) & sin ( {P}_{f} ) cos ( {T}_{f} ) \\ - cos ( {T}_{f} ) & 0 & sin ( {T}_{f} )\end{matrix} ]\end{matrix} \qquad [ Equation 6 ]$$

The coordinates of the point C obtained by rotating the coordinates (R, 0, 0) of the reference point D with the pan angle P_{f} and the tilt angle T_{f} of the point A may be obtained by applying the matrix W of Equation 6. That is, the coordinates (x, y, z) of the point C after the rotational transform is performed may be calculated using Equation 7 below.

$$\begin{matrix}[ \begin{matrix}x \\ y \\ z\end{matrix} ] = W A \\ = [ \begin{matrix}cos ( {P}_{f} ) sin ( {T}_{f} ) & - sin ( {P}_{f} ) & cos ( {P}_{f} ) cos ( {T}_{f} ) \\ sin ( {P}_{f} ) sin ( {T}_{f} ) & cos ( {P}_{f} ) & sin ( {P}_{f} ) cos ( {T}_{f} ) \\ - cos ( {T}_{f} ) & 0 & sin ( {T}_{f} )\end{matrix} ] [ \begin{matrix}R \\ 0 \\ 0\end{matrix} ]\end{matrix} \qquad [ Equation 7 ]$$

Since the pan-tilt-zoom camera image is captured with preset constant ranges of pan and tilt angles, it is common that the pan and tilt angles of the point A do not match. Therefore, an n^{th} image with a pan angle Pₙ and a tilt angle Tₙ closest to the pan angle P_{f} and the tilt angle T_{f} of the point A is found from among a plurality of images of the pan-tilt-zoom camera. In order to obtain the coordinates corresponding to the point A in this image, the coordinates (x, y, z) of the point C are reversely rotated by the pan angle Pₙ and the tilt angle Tₙ. Since a reverse rotation matrix CR is a transposed matrix of Equation 6, it is the same as in Equation 8 below.

$$\begin{matrix}{C}_{R} = {W}^{T} \\ = [ \begin{matrix}cos ( {P}_{n} ) sin ( {T}_{n} ) & sin ( {P}_{n} ) sin ( {T}_{n} ) & - cos ( {T}_{n} ) \\ - sin ( {P}_{n} ) & cos ( {P}_{n} ) & 0 \\ cos ( {P}_{n} ) cos ( {T}_{n} ) & sin ( {P}_{n} ) cos ( {T}_{n} ) & sin ( {T}_{n} )\end{matrix} ]\end{matrix} \qquad [ Equation 8 ]$$

Coordinates (x′, y′, z′) of a point C′ obtained by reversely rotating the coordinates (x, y, z) of the point C may be obtained using Equation 9 below.

$$\begin{matrix}[ \begin{matrix}{x}^{′} \\ {y}^{′} \\ {z}^{′}\end{matrix} ] = {X}^{′} = {C}_{R} X \\ = [ \begin{matrix}cos ( {P}_{i} ) sin ( {T}_{i} ) & sin ( {P}_{i} ) sin ( {T}_{i} ) & - cos ( {T}_{i} ) \\ - sin ( {P}_{i} ) & cos ( {P}_{i} ) & 0 \\ cos ( {P}_{i} ) cos ( {T}_{i} ) & sin ( {P}_{i} ) cos ( {T}_{i} ) & sin ( {T}_{i} )\end{matrix} ] [ \begin{matrix}x \\ y \\ z\end{matrix} ]\end{matrix} \qquad [ Equation 9 ]$$

In the image of the pan-tilt-zoom camera having the pan angle Pₙ and the tilt angle Tₙ, an image location (i, j) may be obtained using Equation 10 below.

$$Img ( i , j ) : i = R \times \frac{{y}^{′}}{{x}^{′}} , j = R \times \frac{{z}^{′}}{{x}^{′}} \qquad [ Equation 10 ]$$

In summary, the coordinates (i, j) obtained using Equation 10 in the n^{th} image with the pan angle Pₙ and the tilt angle Tₙ closest to the pan angle P_{f} and the tilt angle T_{f} of the point A may be mapped to coordinates of a point (Fy, Fx) where the point A at the location of the pan angle P_{f} and the tilt angle T_{f} is photographed in the fisheye image.

According to an additional aspect, the entire surveillance region may be divided into partial surveillance regions having a pan angle smaller than a horizontal FOV of the pan-tilt-zoom camera and a tilt angle smaller than a vertical FOV. When the pan-tilt-zoom camera photographs while changing the pan angle and the tilt angle directed to a center of each divided partial surveillance region 720, a plurality of images 710 and 720 of the entire surveillance region having overlapping portions may be obtained. In this case, since the region with a small tilt angle corresponding to a central portion of the fisheye image has a large overlapping portion, the number of captured images may be reduced by increasing the pan angle interval.

According to an additional aspect, the fisheye image data is updated using a plurality of pieces of partial image data obtained by photographing the entire surveillance region with the pan-tilt-zoom camera at preset periods. The fisheye image data may be provided using image data captured at the time of initial setting, and the fisheye image may be updated by photographing regions divided according to a preset division method periodically or when there is a user's request.

According to an additional aspect, the driving parameter calculating unit 370 calculates the pan angle and the tilt angle to allow the pan-tilt-zoom camera to be directed to the center of the selected portion, and sets the zoom magnification of the pan-tilt-zoom camera using a ratio of an FOV of the selected portion to a preset FOV previously set.

When the selected region is one point 520, the pan angle P_{f} and the tilt angle T_{f} may be obtained using Equation 5. Values of the pan angle P_{f} and the tilt angle T_{f} are set as driving parameters of the camera.

When the selected region includes a range of the region 510 or 530, the pan angle P_{f} and the tilt angle T_{f} may be obtained using the location of the central point, like the case of one point 520. The location of the central point can be used by obtaining an average of pan angles and tilt angles of corner points. In the case of having the region, the zoom magnification may be adjusted to include a pan angle range and a tilt angle range of the region in which the FOV of the camera is set. The preset map may be directly moved using preset driving parameters.

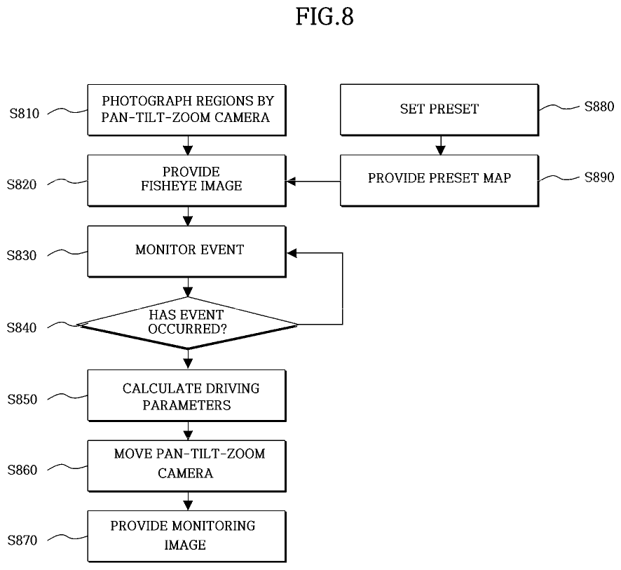

FIG. 8 is a flowchart illustrating a video surveillance method using a camera capable of a pan-tilt-zoom operation according to an embodiment.

The video surveillance method using the camera capable of a pan-tilt-zoom operation includes the following operations. In order to provide a fisheye image, a plurality of images of an entire surveillance region are photographed while changing a pan angle and a tilt angle of the pan-tilt-zoom camera according to a predetermined criterion (S810). In this case, the pan-tilt-zoom camera is moved at an angular interval smaller than an FOV and photographs so as to be overlapped so that omission do not occur in the surveillance region in the plurality of images.

The fisheye image representing the entire surveillance region is provided using the pan-tilt-zoom camera image (S820). The fisheye image may be provided onto a first region of a display.

Events are monitored to determine whether there is an input by the user and other notifications occur (S830). When an event occurs (S840), the event is processed according to a predetermined procedure. When a signal for changing a place where the camera photographs is input by the user, driving parameters of the pan-tilt-zoom camera for moving the camera to a corresponding location are calculated based on location information of a selected portion in the fisheye image (S850). The pan-tilt-zoom camera is moved to a region where the pan-tilt-zoom camera photographs using the calculated driving parameters (S860). A monitoring image of the selected portion photographed by the pan-tilt-zoom camera is provided (S870). The monitoring image may be provided onto a second region of the display.

Meanwhile, a preset, which is a region where photographing is pre-performed, may be set in the fisheye image (S880). The driving parameters for the corresponding region may also be stored in the preset. When the preset is set, a preset map displaying a corresponding photographing location onto the fisheye image may be provided (S890).

According to an additional aspect, in operation S850 of calculating the driving parameters, a pan angle and a tilt angle are calculated to allow the pan-tilt-zoom camera to be directed to a center of the selected portion, and a zoom magnification of the pan-tilt-zoom camera is set using a ratio of an FOV of the selected portion to a preset FOV previously set.

FIG. 9 is a flowchart illustrating an operation of providing a fisheye image in a video surveillance method using a camera capable of a pan-tilt-zoom operation according to an embodiment.

According to an additional aspect, in operation S820 of providing the fisheye image, the fisheye image data is updated using a plurality of pieces of partial image data obtained by photographing the entire surveillance region with the pan-tilt-zoom camera at preset periods.

According to an additional aspect, in operation S820 of providing the fisheye image, the fisheye image data may be generated by synthesizing and distorting a plurality of pieces of partial image data of the entire surveillance region photographed by the pan-tilt-zoom camera. In this case, distortion data may be generated using Equations 1 to 3.

According to an additional aspect, in operation S820 of providing the fisheye image, the fisheye image may be generated by extracting predetermined pixels from the plurality of partial images of the entire surveillance region photographed by the pan-tilt-zoom camera. This method will be described below in detail.

First, in a reference coordinate system in which both a pan angle and a tilt angle are 0 degrees, coordinates (R, 0, 0) of a reference point D at a center of a camera image is obtained (S900). In the pan-tilt-zoom camera, when it is assumed that an FOV is ω and an image length in a direction of the FOV is H, R corresponds to a focal length, and thus the coordinates (R, 0, 0) may be obtained using Equation 4.

R=(H/2)tan(ω/2) [Equation 4]

Next, in a fisheye coordinate system whose origin is a center of a fisheye image, a point A (Fx, Fy) located Fx pixels away from a horizontal axis and Fy pixels away from a vertical axis is selected (S910). Then, a pan angle P_{f} and a tilt angle T_{f} of the point A are obtained using Equation 5 (S920).

P_{f}=arctan(Fy/Fx)

T_{f}=Tₘ*(d/R_{f}) [Equation 5]

Here, Tₘ denotes a tilt range, d denotes a pixel distance from the origin to a point F in the fisheye image, and R_{f} denotes a pixel distance corresponding to a radius of the fisheye image. The tilt range Tₘ may be obtained by adding half of the FOV to a maximum FOV of the fisheye camera or a maximum tilt value of the pan-tilt-zoom camera.

Next, coordinates of a point C obtained by rotating a reference point D with a pan angle and a tilt angle of a point A are calculated (S930). A rotational transform matrix W for rotation with the pan angle P_{f} and the tilt angle T_{f} may be obtained using Equation 6.

$$\begin{matrix}W = [ \begin{matrix}cos ( {P}_{f} ) & - sin ( {P}_{f} ) & 0 \\ sin ( {P}_{f} ) & cos ( {P}_{f} ) & 0 \\ 0 & 0 & 1\end{matrix} ] [ \begin{matrix}sin ( {T}_{f} ) & 0 & cos ( {T}_{f} ) \\ 0 & 1 & 0 \\ - cos ( {T}_{f} ) & 0 & sin ( {T}_{f} )\end{matrix} ] \\ = [ \begin{matrix}cos ( {P}_{f} ) sin ( {T}_{f} ) & - sin ( {P}_{f} ) & cos ( {P}_{f} ) cos ( {T}_{f} ) \\ sin ( {P}_{f} ) sin ( {T}_{f} ) & cos ( {P}_{f} ) & sin ( {P}_{f} ) cos ( {T}_{f} ) \\ - cos ( {T}_{f} ) & 0 & sin ( {T}_{f} )\end{matrix} ]\end{matrix} \qquad [ Equation 6 ]$$

Therefore, when the matrix W of Equation 3 is applied to the coordinates (R, 0, 0) of the reference point D, coordinates (x, y, z) of the point C after the rotational transform is performed may be calculated using Equation 7.

$$\begin{matrix}[ \begin{matrix}x \\ y \\ z\end{matrix} ] = W A \\ = [ \begin{matrix}cos ( {P}_{f} ) sin ( {T}_{f} ) & - sin ( {P}_{f} ) & cos ( {P}_{f} ) cos ( {T}_{f} ) \\ sin ( {P}_{f} ) sin ( {T}_{f} ) & cos ( {P}_{f} ) & sin ( {P}_{f} ) cos ( {T}_{f} ) \\ - cos ( {T}_{f} ) & 0 & sin ( {T}_{f} )\end{matrix} ] [ \begin{matrix}R \\ 0 \\ 0\end{matrix} ]\end{matrix} \qquad [ Equation 7 ]$$

Meanwhile, in a plurality of pan-tilt-zoom camera images captured while changing the pan angle and the tilt angle for the entire surveillance region, a video image Img having a pan angle P_{f} and a tilt angle Tₙ close to the pan angle P_{f} and tilt angle T_{f} of the point A of the fisheye image is selected (S940). An image having a minimum value may be selected as a close-up video image Img by subtracting the pan angle and tilt angle of the point A from the pan angle and tilt angle of the surveillance region image, respectively.

A point C′ is obtained by inversely rotating the point C obtained above with the pan angle Pₙ and tilt angle Tₙ of the close-up video image Img (S950). Since the reverse rotation matrix CR is a transposed matrix of Equation 6, it is the same as in Equation 8.

$$\begin{matrix}{C}_{R} = {W}^{T} \\ = [ \begin{matrix}cos ( {P}_{n} ) sin ( {T}_{n} ) & sin ( {P}_{n} ) sin ( {T}_{n} ) & - cos ( {T}_{n} ) \\ - sin ( {P}_{n} ) & cos ( {P}_{n} ) & 0 \\ cos ( {P}_{n} ) cos ( {T}_{n} ) & sin ( {P}_{n} ) cos ( {T}_{n} ) & sin ( {T}_{n} )\end{matrix} ]\end{matrix} \qquad [ Equation 8 ]$$

Therefore, coordinates (x′, y′, z′) of the point C′ obtained by reversely rotating the coordinates (x, y, z) of the point C may be obtained using Equation 9 below.

$$\begin{matrix}[ \begin{matrix}{x}^{′} \\ {y}^{′} \\ {z}^{′}\end{matrix} ] = {X}^{′} = {C}_{R} X \\ = [ \begin{matrix}cos ( {P}_{i} ) sin ( {T}_{i} ) & sin ( {P}_{i} ) sin ( {T}_{i} ) & - cos ( {T}_{i} ) \\ - sin ( {P}_{i} ) & cos ( {P}_{i} ) & 0 \\ cos ( {P}_{i} ) cos ( {T}_{i} ) & sin ( {P}_{i} ) cos ( {T}_{i} ) & sin ( {T}_{i} )\end{matrix} ] [ \begin{matrix}x \\ y \\ z\end{matrix} ]\end{matrix} \qquad [ Equation 9 ]$$

In the image of the pan-tilt-zoom camera having the pan angle Pₙ and the tilt angle Tₙ, an image location (i, j) of a point B′ may be obtained using Equation 10 (S960).

$$Img ( i , j ) : i = R \times \frac{{y}^{′}}{{x}^{′}} , j = R \times \frac{{z}^{′}}{{x}^{′}} \qquad [ Equation 10 ]$$

Pixels at the image location (i, j) of the point B′ in the image of the pan-tilt-zoom camera having the pan angle Pₙ and the tilt angle Tₙ are copied to the point A (Fx, Fy) of the fisheye image having the pan angle P_{f} and the tilt angle T_{f} (S970). When the formation of the fisheye image is not completed (S980), it is returned to the process of selecting one point of the fisheye image, and the process is repeated until the formation of the fisheye image is completed (S910). When the formation of the fisheye image is completed, information on the pixels extracted from the fisheye image and the pan-tilt-zoom image may be stored in a mapping table (S990).

According to the proposed invention, it is possible to provide a surveillance system that can intuitively, rapidly, and easily control a pan-tilt-zoom camera from a fisheye image by simultaneously providing a fisheye image and a pan-tilt-zoom camera image.

Further, according to the proposed invention, a method of mapping pixels required for a fisheye image in a pan-tilt-zoom camera image is used, and thus computational resources can be saved and the fisheye image can be rapidly formed.

Further, according to the proposed invention, a fisheye image can be formed from a pan-tilt-zoom camera image, and thus a surveillance system can be configured simply and inexpensively and can be easy to maintain.

While exemplary embodiments of the present invention have been described with reference to the accompanying drawing, the present invention is not limited to the exemplary embodiments. It should be interpreted that various modifications that can be apparently made by those skilled in the art are included in the scope of the present invention. The appended claims are intended to cover the modifications.

What is claimed is:

1. A camera device capable of a pan-tilt-zoom operation, comprising:
a memory configured to store monitoring image data; and
a processor electrically coupled to the memory,
wherein the processor is configured to generate a fisheye image representing an entire surveillance region,
calculate driving parameters for the pan-tilt-zoom operation on the basis of location information of a portion selected from the fisheye image, and
output data of the monitoring image obtained by capturing the selected portion.

2. The camera device of claim 1, wherein the fisheye image is generated by extracting predetermined pixels from a partial image captured in each of partial regions divided by a preset method, among the entire surveillance region.

3. The camera device of claim 1, wherein the fisheye image is updated using pieces of image data for a partial region rephotographed for each of partial regions divided by a preset method, among the entire surveillance region, at preset periods.

4. The camera device of claim 1, wherein the processor is further configured to display, on the fisheye image, a preset region in which a location where photographing is performed is preset, among the surveillance region.

5. The camera device of claim 1, wherein the driving parameters include:
a pan angle and a tilt angle for photographing a center of the selected portion; and
a zoom magnification set by a ratio of a field of view of the selected portion to a field of view of a camera.

6. A video surveillance system using a camera capable of a pan-tilt-zoom operation, comprising:
a camera capable of a pan-tilt-zoom operation configured to photograph a surveillance region;
a display configured to output an image of the camera; and
a control unit configured to drive the camera and transmit an image captured by the camera to the display,
wherein the control unit includes a fisheye image providing unit that provides a fisheye image representing an entire surveillance region to a first region of the display,
a driving parameter calculating unit that calculates driving parameters for the pan-tilt-zoom operation of the camera on the basis of location information of a portion selected from the fisheye image, and
a monitoring image providing unit that provides a monitoring image obtained by capturing the selected portion to a second region of the display.

7. The video surveillance system of claim 6, wherein the fisheye image providing unit provides a fisheye image generated by synthesizing and distorting a plurality of partial images obtained by capturing preset partial regions obtained by dividing the entire surveillance region.

8. The video surveillance system of claim 6, wherein the fisheye image providing unit provides a fisheye image generated by extracting predetermined pixels from each of partial images obtained by capturing preset partial regions obtained by dividing the entire surveillance region.

9. The video surveillance system of claim 6, wherein the control unit further includes a preset map providing unit that displays, on the fisheye image, a preset region in which a location where photographing is performed is preset, among the surveillance region.

10. The video surveillance system of claim 6, wherein the driving parameter calculating unit is configured to calculate a pan angle and a tilt angle to allow the camera to be directed to a center of the selected portion, and
set a zoom magnification using a ratio of a field of view of the selected portion to a field of view of the camera.

11. A video surveillance method using a camera capable of a pan-tilt-zoom operation, comprising:
providing a fisheye image representing an entire surveillance region;
calculating driving parameters for the pan-tilt-zoom operation of the camera on the basis of location information of a portion selected from the fisheye image;
moving the camera to be directed to the selected portion using the driving parameters; and
providing a monitoring image of the selected portion photographed by the camera.

12. The video surveillance method of claim 11, wherein the providing of the fisheye image includes:
dividing the entire surveillance region into preset partial regions and capturing a partial image in each of the partial regions; and
extracting predetermined pixels from each captured partial image and generating the fisheye image.

13. The video surveillance method of claim 11, further comprising providing a preset map that displays, on the fisheye image, a preset region in which a location where photographing is performed is preset, among the surveillance region.

14. The video surveillance method of claim 11, wherein the calculating of the driving parameter includes:
calculating a pan angle and a tilt angle to allow the camera to be directed to a center of the selected portion; and
set a zoom magnification of the camera using a ratio of a field of view of the selected portion to a field of view of the camera.
